(19) United States
(12) Patent Application Publication
(10) Pub. No.: US 2007/0118481 A1
(43) Pub. Date: May 24, 2007

(54) Method and apparatus for monitoring software usage

(76) Inventors: Erik Bostrom, Fort Collins, CO (US); Michael James Guerette, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/285,849

(22) Filed: Nov. 22, 2005

(51) Int. Cl. G06Q 99/00

(52) U.S. Cl. 705/59

(57) ABSTRACT

In one embodiment, and in accord with a method for monitoring software usage, a periodic determination is made as to how many of a particular hardware resource are active within a defined computing environment. Then, in accord with a number of the particular hardware resources that are determined to be active in the defined computing environment during a given time period, i) a count of permanent licenses, if any, that are available in a usage account of a software application configured to use the defined computing environment, is debited, and ii) upon exhausting the count of permanent licenses, a count of time increments, if any, for which a number of temporary licenses in the usage account of the software application are valid, is debited. Other embodiments are also disclosed.

### BACKGROUND

Software vendors are increasingly being pushed to provide utility licensing (i.e., use-based licensing) for their software. This push has intensified as utility licensing has grown in popularity for the acquisition and use of hardware resources.

Typically, utility licensing for software is accomplished by 1) modifying a software application to include a software monitoring process that tracks when and where the software application is used, or 2) requiring a user to install and maintain, and possibly even purchase, a stand-alone software monitoring process. The first solution is particularly burdensome to software vendors, while the second solution is particularly burdensome for software users.

### BRIEF DESCRIPTION OF THE DRAWINGS

Illustrative embodiments of the invention are illustrated in the drawings, in which:

FIG. 1 illustrates an exemplary new method for monitoring software usage; and

FIG. 2 illustrates an exemplary computing environment in which the FIG. 1 method may be implemented.

### DETAILED DESCRIPTION

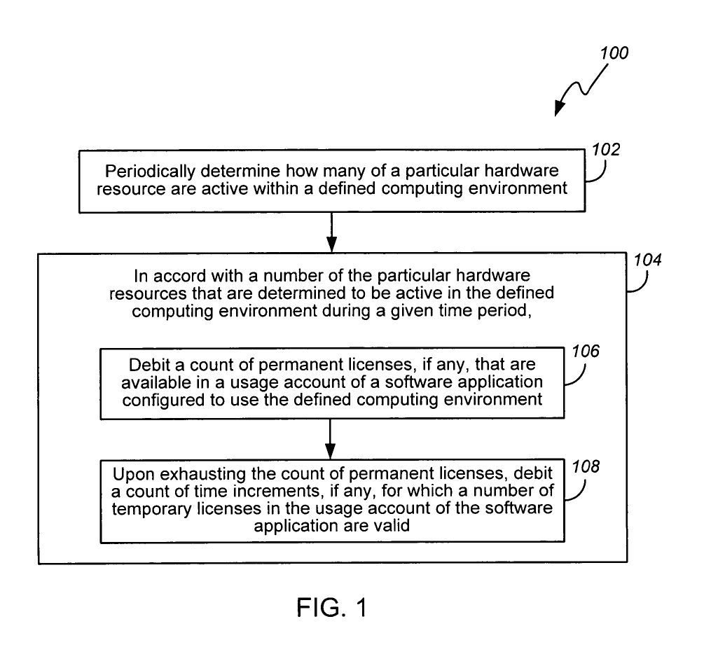

FIG. 1 illustrates an exemplary new method 100 for monitoring software usage. The method 100 comprises periodically determining 102 how many of a particular hardware resource are active within a defined computing environment. By way of example, the defined computing environment may be a server, a resource partition (including a virtual machine or server), or an operating system instance; and the particular hardware resource may be a processor, a resource partition (including a virtual machine or server), a server blade, or a memory unit.

In accord with a number of the particular hardware resources that are determined to be active in the defined computing environment during a given time period 104 (e.g., an hour, day or week), the method 100 debits 106 a count of permanent licenses, if any, that are available in a usage account of a software application configured to use the defined computing environment. Upon exhausting the count of permanent licenses, the method 100 then debits 108 a count of time increments, if any, for which a number of temporary licenses in the usage account of the software application are valid.

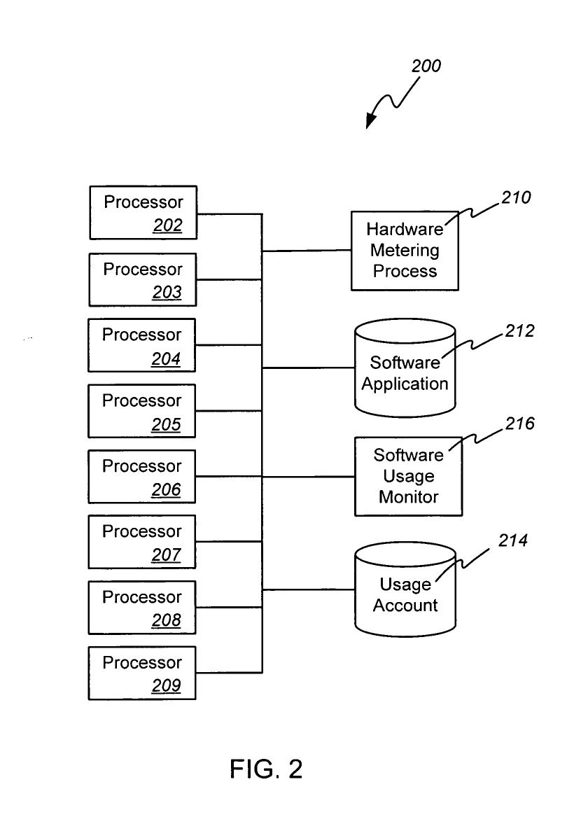

FIG. 2 illustrates an exemplary computing environment 200 in which the method 100 may be implemented. The computing environment comprises a number of processors 202, 203, 204, 205, 206, 207, 208, 209, a hardware metering process 210, a software application 212, a usage account 214 that is associated with the software application, and a software usage monitor 216.

During operation of the computing environment 200, only some of its hardware resources (e.g., the processors 202-209) may be active in any given time period. For example, if the computing environment 200 is a server, the server may be provided to a user with one active processor 202, and a plurality of additional processors 203-209 that may be activated “on demand” when the server's user, or some process that the user has installed, determines that the user's processing demands exceed the capabilities of the server's currently active processors. In a similar fashion, some computing environments may be provided with entire servers, resource partitions or plural operating system instances that a user or computer process may activate or de-activate.

In response to the changing number of active processors in the computing environment 200, the hardware metering process 210 periodically determines how many of the processors 202-209 are active. By way of example, a processor may be determined to be active when 1) the processor is executing any process, 2) when the processor is executing any non-idle process (e.g., where an “idle” process might be a process that merely checks an address or register for an indication signifying that execution of another process should begin), or 3) when the processor is operating above a threshold capacity.

In some cases, the hardware metering process 210 may be an agent that runs within the computing environment 200.

The usage account 214 that is associated with the software application 212 may comprise a number of permanent licenses, each of which authorizes use of the software application in conjunction with a particular number of hardware resources (such as four processors) for a permanent or relatively long period of time. The usage account 214 may also comprise a number of temporary licenses, each of which authorizes use of the software application in conjunction with a particular number of hardware resources, but only for a number of time increments (e.g., days or weeks). Although the usage account 214 may comprise both permanent and temporary licenses, it may sometimes include only one license type (or no licenses at all). Alternately, or additionally, the usage account 214 might only comprise a “count” of permanent licenses, and either a “count” of temporary licenses or a “count” of the number of time increments that a number temporary licenses authorize. By way of example, the usage account 214 may be maintained as a single license file, or may be distributed over multiple files. The usage account 214 may also be stored in permanent or temporary storage (e.g., on disk, or in memory).

During operation of the computing environment 200, the software usage monitor 216 receives or acquires periodic reports from the hardware metering process 210. Then, and in accord with a number of the processors 202-209 that are active within the computing environment 200 during a given time period (e.g., an hour, day or week), the software usage monitor 216 debits a count of permanent licenses, if any, that are available in the usage account 214. Upon exhausting the count of permanent licenses, the software usage monitor 216 then debits a count of time increments, if any, for which a number of temporary licenses in the usage account 214 are valid.

By way of example, the software usage monitor 216 and hardware metering process 210 may take the form of one or more applications or services that are embodied in computer-readable program code stored on one or more computer-readable media. The computer-readable media may include, for example, any number or mixture of fixed or removable media (such as one or more fixed disks, random access memories (RAMs), read-only memories (ROMs), or compact discs), at either a single location or distributed over a network.

Preferably, a user of the computing environment 200 purchases a number of permanent licenses that is sufficient to operate the software 212 under “normal” hardware use conditions—whatever those may be based on the user's day-to-day use (i.e., activation) of the processors 202-209. The user may then purchase a number of temporary licenses that is sufficient to operate the software 212 under “peak” hardware use conditions. For example, if the computing environment 200 is normally operated with four active processors 202-205, but then once a month, two more processors 206, 207 are activated for a period of five days, the user might wish to purchase 1) four permanent licenses, each of which allows the software 212 to be run on one processor, and 2) one temporary license that allows the software 212 to be run for 120 processor days. The temporary license would then enable the two additional processors 206, 207 to be activated five days a month over the course of one year.

In some cases, a count of time increments may be allowed to decrement below zero. In these cases, a user may be allowed to use software that has not been properly licensed, and the “overage” of the user's software use may be reported to a software vendor or other billing entity for the purpose of billing a user “after use”.

Upon exhausting a count of time increments for which a number of temporary licenses in a usage account 214 are valid, various actions may be taken. In one embodiment, a user of the defined computing environment may be notified. In another embodiment, a license management process may be notified. In yet another embodiment, the software application 212 may be prevented from executing in the defined computing environment 200, or may by prevented from using a number of resources in the defined computing environment 200 (such as resources for which appropriate licensing does not exist). In this last embodiment, the software application 212 may be prevented from using the number of resources by disabling the number of resources. The actions that may be taken upon exhaustion of a count of time increments for which a number of temporary licenses are valid, or upon exhaustion of all licenses, may further include other actions, or combinations of the above actions.

What is claimed is:

1. A method for monitoring software usage, comprising:
periodically determining how many of a particular hardware resource are active within a defined computing environment; and
in accord with a number of the particular hardware resources that are determined to be active in the defined computing environment during a given time period, i) debiting a count of permanent licenses, if any, that are available in a usage account of a software application configured to use the defined computing environment, and ii) upon exhausting the count of permanent licenses, debiting a count of time increments, if any, for which a number of temporary licenses in the usage account of the software application are valid.

2. The method of claim 1, wherein the particular hardware resource is a processor.

3. The method of claim 2, wherein a processor is determined to be active when the processor is executing any process.

4. The method of claim 2, wherein a processor is determined to be active when the processor is executing any non-idle process.

5. The method of claim 2, wherein a processor is determined to be active when the processor is operating above a threshold capacity.

6. The method of claim 1, wherein the particular hardware resource is a resource partition.

7. The method of claim 1, wherein the particular hardware resource is a server blade.

8. The method of claim 1, wherein the particular hardware resources is a memory unit.

9. The method of claim 1, wherein the defined computing environment is a server.

10. The method of claim 1, wherein the defined computing environment is a resource partition.

11. The method of claim 1, wherein the defined computing environment is an operating system instance.

12. The method of claim 1, further comprising, upon exhausting the count of time increments for which the number of temporary licenses in the usage account of the software application are valid, notifying a user of the defined computing environment.

13. The method of claim 1, further comprising, upon exhausting the count of time increments for which the number of temporary licenses in the usage account of the software application are valid, notifying a license management process.

14. The method of claim 1, further comprising, upon exhausting the count of time increments for which the number of temporary licenses in the usage account of the software application are valid, preventing the software application from executing in the defined computing environment.

15. The method of claim 1, further comprising, upon exhausting the count of time increments for which the number of temporary licenses in the usage account of the software application are valid, preventing the software application from using a number of resources in the defined computing environment.

16. The method of claim 15, wherein preventing the software application from using the number of resources comprises disabling the number of resources.

17. A computing environment, comprising:
a number of processors, only some of which may be active in any given time period;
a hardware metering process to periodically determine how many of the processors are active;
a software application configured to use the active ones of the processors;
a usage account associated with the software application; and
a software usage monitor to, in accord with a number of the processors that the hardware metering process determines to be active during a given time period, i) debit a count of permanent licenses, if any, that are available in the usage account, and ii) upon exhausting the count of permanent licenses, debit a count of time increments, if any, for which a number of temporary licenses in the usage account of the software application are valid.

18. A software usage monitor, comprising:
program code to, in accord with a number of particular hardware resources that are determined to be active in a defined computing environment during a given time period, debit a count of permanent licenses, if any, that are available in a usage account of a software application configured to use the defined computing environment; and
program code to, upon exhausting the count of permanent licenses, debiting a count of time increments, if any, for which a number of temporary licenses in the usage account of the software application are valid.

19. Apparatus, comprising:
a number of computer-readable media; and
computer-readable program code, stored on the computer-readable media, including:
code to, in accord with a number of particular hardware resources that are determined to be active in a defined computing environment during a given time period, debit a count of permanent licenses, if any, that are available in a usage account of a software application configured to use the defined computing environment; and
code to, upon exhausting the count of permanent licenses, debit a count of time increments, if any, for which a number of temporary licenses in the usage account of the software application are valid.

20. The apparatus of claim 19, wherein the particular hardware resource is a processor.

21. The apparatus of claim 20, wherein a processor is determined to be active when it is executing any non-idle process.

22. The apparatus of claim 19, wherein the defined computing environment is a server.

23. The apparatus of claim 19, wherein the defined computing environment is a resource partition.

24. The apparatus of claim 19, wherein the defined computing environment is an operating system instance.

25. The apparatus of claim 19, wherein the computer-readable program code further comprises code to, upon exhausting the count of time increments for which the number of temporary licenses in the usage account of the software application are valid, notify a user of the defined computing environment.

26. The apparatus of claim 19, wherein the computer-readable program code further comprises code to, upon exhausting the count of time increments for which the number of temporary licenses in the usage account of the software application are valid, notify a license management process.
